(19) United States
(12) Patent Application Publication
(10) Pub. No.: US 2019/0141900 A1
(43) Pub. Date: May 16, 2019

(54) HEART OF PALM PROCESSING

(71) Applicant: BB FOODS LLC, Pflugerville, TX (US)

(72) Inventors: Dennis BYRNE, Maple Grove, MN (US); Marcio BASSO, Sao Paulo (BR); Marco BASSO, Uberlandia MG (BR); Michael BYRNE, Pflugerville, TX (US)

(21) Appl. No.: 16/079,334

(22) PCT Filed: Jul. 11, 2017
(86) PCT No.: PCT/US17/41607

§ 371 Date: Aug. 23, 2018

Related U.S. Application Data
(60) Provisional application No. 62/360,881, filed on Jul. 11, 2016.

(51) Int. Cl. A01F 11/08; A23B 7/005; A23L 19/00; A23L 3/37; A23N 11/00

(52) U.S. Cl. CPC A01F 11/08; A23B 7/0056; A23N 11/00; A23L 3/37; A23L 19/03

(57) ABSTRACT

Heart of palm may be harvested from palm trees as a source of food. The core of a heart of palm heart is more desirable than the base of the palm heart due to its more favorable characteristics, resulting in under-utilization and waste of the base. The base and core may be processed in ways that advantageously utilize the base and overcome differences in density and inherent taste properties between the two sections. In an example, the base is treated with a cleaning solution and pieces are formed from the base. In this example, the pieces are immersed in an acid solution and packaged in an oxygen-impermeable packaging medium. The resulting heart of palm base pieces have favorable taste and mouthfeel and the pieces derived from the base are indistinguishable from pieces derived from the core.

### BACKGROUND

Heart of palm (also referred to as palm heart) is a vegetable harvested from some species of wild or cultivated palm trees. During harvest, a stem or trunk of a palm tree is cut from the roots and the crown or canopy is removed from the top of the stem. The heart is within the stem surrounded by an outer sheath. The heart of palm has three portions: an exposed bulbous base, a cylindrical body of leaf sheaths surrounding an inner core of less-developed petioles and leaflets, and an exposed top of free leaflets. The base, core, and leaflets of the heart of palm are edible. The base and core are comprised of tender rachis and leaflets, with the core having a roll-like or tube-like shape.

Fresh heart of palm may be harvested for personal consumption but most commonly is processed and distributed commercially. Commercial processing involves removing the leaf sheaths, top, and base from the core. The core is then cut to certain lengths and distributed as a fresh or packaged product. The base, while edible, is more difficult to process than the core due to its bulbous shape and its denser, more fibrous structure. Additionally, the base typically has a less pleasant odor than the core. The base also has a taste that is less preferable than the taste of the core due, at least in part, to these characteristics. Thus, even though the base and core are both part of the heart of palm, they cannot be processed the same to get the same product. The base is therefore routinely discarded during commercial processing in favor of the core because the core has more desirable qualities.

Existing methods for processing the core are unsuitable for processing the base into a high-quality product with desirable characteristics like those of the core, and result in less valuable and inefficient uses of the base. Some commercial processing units may process the base, but only as a low-grade material with a significantly lower value than the core due to the inferior qualities of the base. The base may also be used simply as mulch or composting material, which avoids complete waste, but are still inefficient uses of the palm heart.

Accordingly, there is a need for systems and methods for processing heart of palm base that address these challenges to prevent waste and allow for greater utilization of the plant. There is also a need for improved heart of palm base products with desirable properties like those of heart of palm core.

### SUMMARY

Systems and methods for processing heart of palm base and heart of palm base products are disclosed herein.

In an aspect, a method for processing a palm heart base includes providing a palm heart including a top, a core, and a base. The base is separated from the top and the core. The base is rinsed with a cleaning solution and a plurality of pieces having a thickness of 0.65 cm or less is formed from the base. The plurality of pieces is immersed in an acidic solution. The plurality of pieces is placed within an oxygen-impermeable packaging medium. The plurality of pieces is heated to a surface temperature of at least 90 degrees Celsius. The plurality of pieces have a shear strength substantially the same as a shear strength of a fresh palm heart core.

In another aspect, a palm heart base product has a plurality of palm heart base pieces having a thickness of 0.65 centimeters or less contained within an oxygen-impermeable packaging medium, and having a shear strength substantially the fresh palm heart core having at least the same thickness as the plurality of pieces.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

Aspects of the herein described systems and methods for processing heart of palm base are described more fully herein with reference to the accompanying drawings, in which example embodiments are shown. Numerous specific details are set forth in the following description for purposes of explanation in order to provide an understanding of the various embodiments. However, the instant disclosure may be embodied in many different forms and should not be construed as limited to the example embodiments set forth herein. Like numbers refer to like elements throughout.

FIG. 1 illustrates an exemplary heart of palm.

FIG. 2 illustrates an exemplary sectioned heart of palm.

FIG. 3 illustrates an exemplary sectioned heart of palm.

FIG. 4 illustrates an isometric view of an exemplary heart of palm base.

FIG. 5 is a depiction of an exemplary flow chart illustrating aspects of the present disclosure.

FIG. 6 is a depiction of an exemplary flow chart illustrating aspects of the present disclosure.

FIG. 7 is a depiction of an exemplary flow chart illustrating aspects of the present disclosure.

FIG. 8 is a depiction of an exemplary flow chart illustrating aspects of the present disclosure.

FIG. 9 is a depiction of an exemplary flow chart illustrating aspects of the present disclosure.

### DETAILED DESCRIPTION OF ILLUSTRATIVE EMBODIMENTS

The palm heart base products disclosed herein have properties the same as or substantially the same as fresh palm heart core. Fresh heart palm core may be considered as palm heart core harvested from a live plant within 24 hours or palm heart core subjected to processes to preserve its fresh characteristics. The pieces maintain those qualities for at least six months unless the packaging is compromised or there is other outside interference. The properties include, for example, odor, taste, texture, density, and crispness. These may be reflected in characteristics such as fracturability, hardness, shear strength. The palm heart pieces may have a fracturability the same as or substantially the same as fresh palm heart core of the same dimensions. Substantially the same fracturability means, in this context, a fracturability within 5% of the fracturability of fresh palm heart core. It may also mean a fracturability within 10% of the fracturability of fresh palm heart core. It may also mean a fracturability within 15% of the fracturability of fresh palm heart core. The palm heart pieces may have a shear strength the same as or substantially the same as fresh palm heart core of the same dimensions (such as thickness, width, length, diameter). Substantially the same shear strength means, in this context, a shear strength within 5% of the shear strength of fresh palm heart core. It may also mean a shear strength within 10% of the shear strength of fresh palm heart core. It may also mean a shear strength within 15% of the shear strength of fresh palm heart core. The palm heart pieces may have an odor the same as or substantially the same as fresh palm heart core of the same dimensions. Odor comparisons can be made using techniques such as solid phase microextraction along with gas chromatograph-mass spectrometers (GC-MS) with olfactometric detection/ports. Substantially the same odor means, in this context, an odor (as represented on an olfatogram or ion chromatogram) within 5% of the odor (as represented on an olfatogram or ion chromatogram) of fresh palm heart core. It may also mean an odor (as represented on an olfatogram or ion chromatogram) within 10% of the odor of fresh palm heart core. It may also mean an odor (as represented on an olfatogram or ion chromatogram) within 15% of the odor of fresh palm heart core.

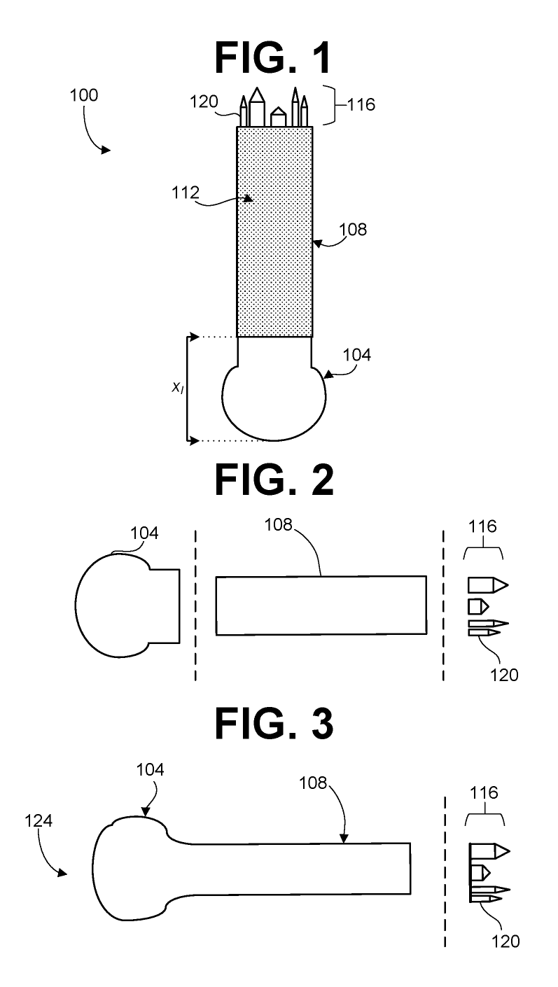

FIG. 1 illustrates exemplary heart of palm 100. Heart of palm 100 is harvested from a wild or cultivated palm tree. Species of palm trees appropriate for harvesting heart of palm 100 include, for example, acrocomia aculeata, aiphanes aculeata, arenga pinnata, acoelorrhaphe wrightii, and attalea geraensis. Harvesting may include separating heart of palm base 104 from a root system of the palm tree through use of a bladed instrument. The canopy of the palm may also be removed and top of heart 116 exposed. Top of heart 116 includes leaflets 120. Core 108 is covered by outer sheath 112, as indicated by shading, while base 104 is uncovered. While the shading in the drawing is uniform, outer sheath 112 may be non-uniform due to, for example, damage to its surface. Outer sheath 112 may be, for example, a fibrous mat or bark. Base 104 generally has a bulbous shape and length x₁ generally between 10 cm and 20 cm. Base 104 is connected with core 108, which is the cylindrical portion of heart of palm 100.

FIG. 2 illustrates heart of palm 100 after sectioning according to an example and removal of outer sheath 112. Core 108 is shown with outer sheath 112 removed. Outer sheath 112 may be removed before or after any sectioning. Removal of outer sheath 112 reveals core 108. Core 108 has a cylindrical or approximately cylindrical shape (being generally uniform in diameter along its length, but not necessarily exactly uniform). Base 104 and top 116 may be separated from core 108. Top 116 may be separated from core 108 by cutting any leaflet growths extending from the end of core 108. This may form an even or relatively even plane along the end of core 108. A sharp-edged instrument may be used to separate the sections of heart of palm 100. Sectioning can be accomplished by, for example, electric, motorized, hand, or hydraulically-powered tools.

FIG. 3 illustrates another example of heart of palm 100 after removal of outer sheath 112 and sectioning. In this example, partial heart 124 includes the connected base 104 and core 108 without top 116, which is from core 108. As shown, top 116 may be removed from core 108 by removing a layer of core 108 adjacent to top 116, or by directly removing the leaflets 120.

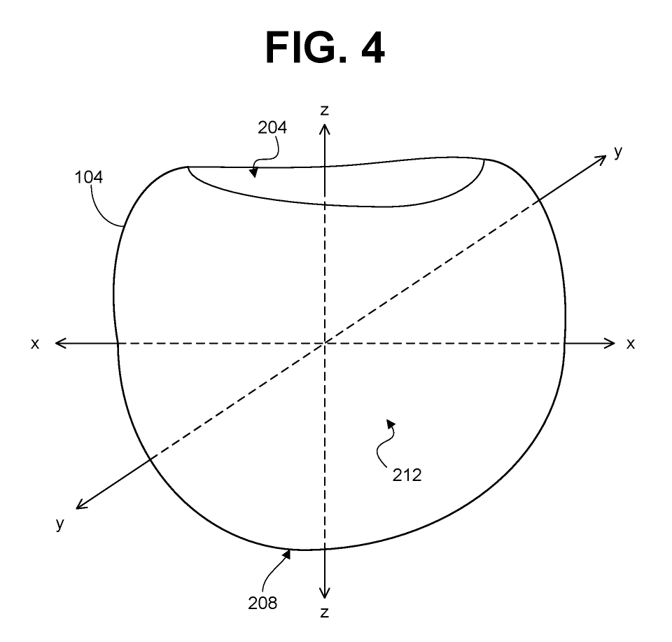

FIG. 4 is an exemplary illustration of base 104. FIG. 4 includes vertical axis z defined from bottom end 208 of base 104 (end deepest in ground or closest to ground when heart of palm 100 was still part of the palm tree) to top end 204 of base 104 (end where core 108 and base 104 are connected prior to separation). FIG. 4 also shows transverse axis x of base 104 and longitudinal axis y. Base 104 has curved outer surface 212. The grain of the heart of palm runs vertically.

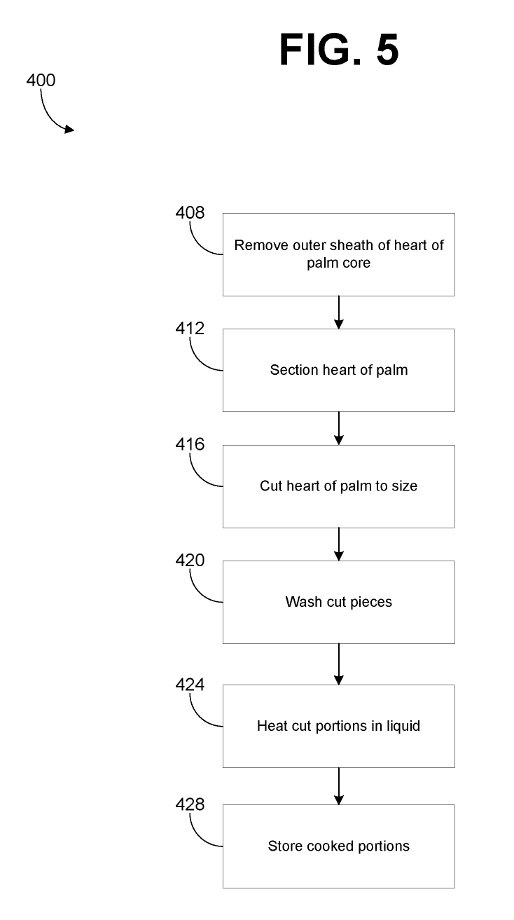

FIG. 5 is a depiction of an exemplary flow chart of method for processing heart of palm 400 illustrating aspects of the present disclosure.

At 408, outer sheath 112 is removed from core 108. Removal may be accomplished by, for example, cutting outer sheath 112 from core 108. The thickness of outer sheath 112 (and the depth to cut to remove sheath but not cut into core 108) may be determined by, for example, inspection of one or both axial ends of core 108. If base 104 and top 116 are still present, it may still be determined because outer sheath 112 does not extend over either base 104 or top 116.

At 412, heart of palm 100 is sectioned. Sectioning heart of palm 100 may include separating top 116 and base 104 from core 108, as illustrated by FIG. 2. As another example, sectioning heart of palm 100 may include separating top 116 from partial heart 124, as illustrated by FIG. 3. Separating may be achieved by, for example, cutting heart of palm 100 transversely as indicated by the dashed lines shown in FIG. 3.

At 416, sectioned heart of palm 100 is portioned. Portioning heart of palm 100 may include dividing heart of palm 100 or sections of heart of palm 100, such as base 104, core 108, or partial heart 124. For example, heart of palm 100 may be sectioned by separating base 104, core 108, and top 116. Separating may include isolating a section of heart of palm 100, such as, for example, base 104. Separating may include cutting heart of palm 100.

Sets of pieces of base 104 and core 108 may be formed, for example, from base 104 and core 108. Sets of pieces of base 104 and core 108 may be grouped separately and not comingled due to their differences in processing. Pieces of base 104 or core 108 may be formed by cutting base 104 or core 108, respectively. Cuts of base 104 may include, for example, vertical cuts, longitudinal cuts, and transverse cuts, as those axes are shown in FIG. 2. As another example, cutting may track surface 212 of base 104, such as by shaving surface 212. One or more cuts or types of cuts may be used to portion heart of palm 100 made at the same time or at different times. For example, a longitudinal cut and a transverse cut may be made at the same time or in a sequence. Portioning may include a series of cuts of one or more types of cuts to produce pieces of base 104 or core 108. The pieces may be formed into shapes, such as, for example, ribbons, sheets, or wires. Portioning heart of palm 100 may result in pieces of uniform or roughly uniform size and shape. Pieces of base 104, for example, may be formed such that they may have a thickness of, for example, 0.65 cm or less.

For example, a ribbon piece may have a length of, for example, 6 to 10 cm, a width of, for example, 0.5 cm to 3 cm, or, as another example, less than 4 cm, and a thickness of, for example, 1 cm or less, or, as another example, 0.65 cm or less. A ribbon piece may be formed from base 104 by, for example, by a cross-grain (i.e., through the horizontal plain) cut to base 104 to remove a portion of base 104 of the desired length (for example, 10 cm). A cut with the grain (i.e., through the vertical plane) may be used to cut to the desired width (for example, 2 cm). As another example, a sheet piece may have a length of, for example, 4 to 10 cm, and which may be equal to the width; a width of, for example, 4 to 10 cm, which may be equal to the length; a thickness of 1 cm or less, or, as anther example, 0.65 cm or less. A ribbon piece may be formed from base 104 by, for example, by a cross-grain (i.e., through the horizontal plain) cut to base 104 to remove a portion of base 104 of the desired length (for example, 6 cm). A cut with the grain (i.e., through the vertical plane) may be used to cut to the desired width (for example, 6 cm).

At 420, heart of palm base 104 or pieces formed from base 104 are washed. Accordingly, washing is not limited to occurring only after 412 or 416 and is not limited to occurring once; washing may occur, for example, prior to 412 or 416. For example, heart of palm 100 may be sectioned by separating base 104, top 116, and core 108. Base 104 and core 108 may then be washed. Some or all of heart of palm 100 may be washed. For example, base 104 may be washed while core 108 is not. Washing may include rinsing heart of palm 100. Heart of palm 100 may be rinsed with, for example, one or more of water, vinegar, a solution of vinegar and water, or food-grade cleaners or acid. Water used to wash (including for rinsing) heart of palm 100 may be first heated to a temperature of, for example, at least 54° C.

For example, water may be heated to a temperature of approximately 57° C. (135° F.). Heart of palm 100 or a section of heart of palm 100, such as base 104, or portioned pieces of heart of palm 100, such as cut pieces of base 104, may then be immersed in the heated water for 5 minutes to 10 minutes. After removal from the heated water bath, heart of palm 100 is rinsed with water. Rinsing may be performed until the water, after being used to rinse heart of palm 100, is relatively free of sediment. This may be determined by, for example, visual inspection of the water to determine that the water is clear and non-cloudy. Heart of palm 100 may be rinsed for a period of time inversely (negatively) correlated with the temperature of the water used for the rinsing. For example, a rinse using relatively cold water (water at a temperature of less than around 23° C.) may be performed for longer than a rinse using relatively warm water (water at a temperature above around 23° C.). In other words, the colder or warmer the water used as the rinse the longer or shorter the duration of the rinsing performed may be. Rinsing may be performed by, for example, placing heart of palm 100, section of heart of palm 100, or cut portions of heart of palm 100 within a flow of the liquid used for the rinse, or the flow of the rinse liquid may be directed against heart of palm 100.

At 424, cut portions of heart of palm 100, are heated in a liquid. The liquid may be, for example, water or may be a solution. The solution may include salts, such as food-grade salts including sodium chloride and calcium chloride, or acids, such as food-grade acids including citric acid, ascorbic acid, and phosphoric acid, sugar, such as sucrose or fructose, artificial sweeteners, other spices or additives, or some combination of them. The liquid may be brought to at a specific temperature, such as a temperature of at least 71° C. (160° F.) and at most 121° C. (250° F.). The solution may have a pH of less than 4.5. For example, the solution may have a pH of 2.0 to 2.2 pH. For example, for the liquid, water may be reduced to a pH of 4.5 or less by the addition of one or more food-grade acids. This may be achieved by adding, for example, 7-9 grams of citric acid powder per liter of water. Cut portions of heart of palm 100 may be partially or wholly submerged in the liquid after the liquid reaches the appropriate temperature, or it may be partially or wholly submerged while the liquid is heated to that temperature. The cooking time for the portioned heart of palm 100 may be, for example, at least 5 minutes and at most 75 minutes.

At 428, the cooked cut portions are stored in a low-oxygen environment and maintained in a liquid with a pH of less than 4.5. For example, the cooked cut portions may be maintained in a solution of citric acid and water. The liquid used for storing the cooked cut portions may be the same liquid used at 424 to cook the pieces or include the same liquid used at 424 to cook the pieces. It may be the same liquid, but not drawn from the same volume used at 424 to cook the pieces.

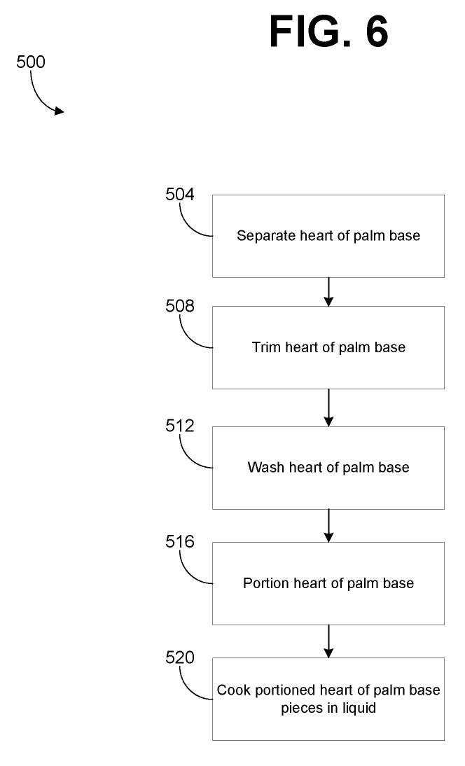

FIG. 6 is a depiction of an exemplary flow chart of method for processing heart of palm base 500.

At 504, base 104 is separated from core 108. Base 104 may be separated from core 108 by, for example, cutting heart of palm 100 transversely at the point outer sheath 108 terminates.

At 508, heart of palm base 104 is trimmed. Trimming may also occur, for example, after 508. Trimming may result in base 104 having a cylindrical form which may have a diameter, for example, equal or approximately equal to the diameter of core 108. Trimming may result in base 104 having a desired length. For example, base 104 may be cut against the grain (against the direction the fibers run) to reduce length. Base 104 may also be trimmed to remove irregular edges, surfaces, knots, buds, or other features.

At 512, base 104 is washed. Washing may include immersing base 104 in water at a temperature of a 100° C. for less than five minutes. Washing may also include rinsing base 104. Base 104 may be rinsed with, for example, water until the water used to rinse is free of sediment after it is used for rinsing base 104.

At 516, base 104 is portioned. Portioning may also occur, for example, before 512. Portioning may include deriving one or more pieces from base 104. Pieces may be uniform in shape. Pieces may be, for example, sheets or ribbons, as disclosed herein. The thickness of the pieces may be, for example, 1 centimeter or less. Dimensions are provided for exemplary purposes only and, according to alternative embodiments, may vary. Base 104 may already be the desired length of the piece and cutting with the grain creates a piece of the desired width and thickness from base 104. In an example, base 104 may be forced through a fixed cutting edge.

At 520, the pieces of heart of palm base 104 are cooked. For example, the pieces may be cooked in a solution of water and citric acid at a temperature of 100° C. for 55 minutes.

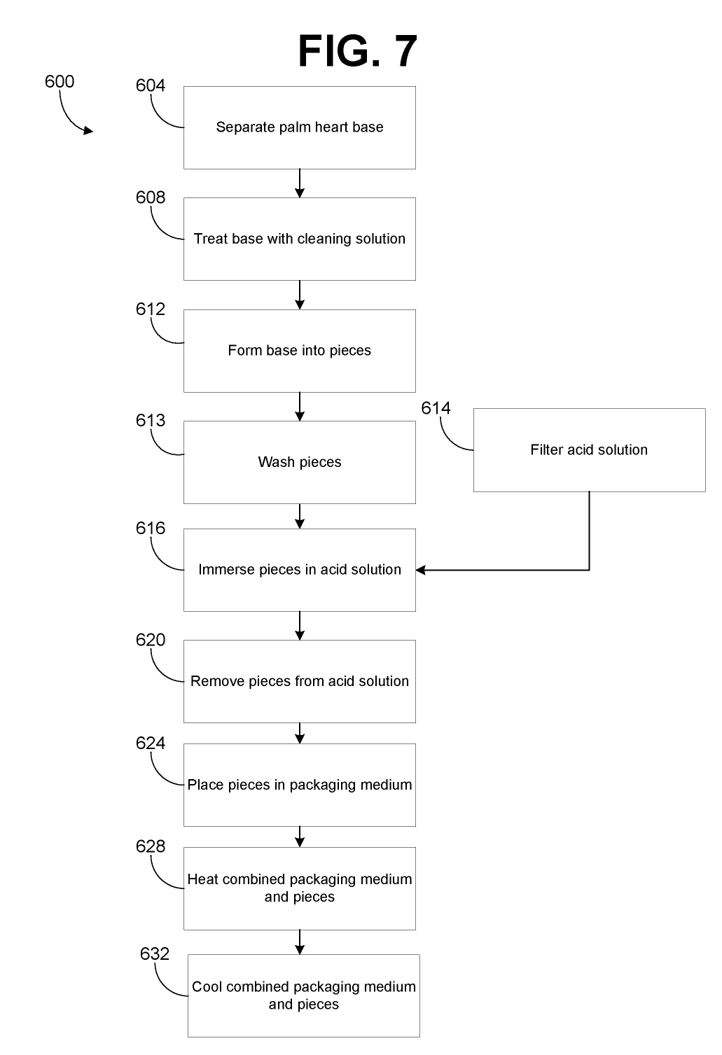

FIG. 7 is a depiction of an exemplary flow chart of method for processing heart of palm base 600.

At 604, base 104 is separated from core 108 and top 116, as disclosed herein.

At 608, base 104 is treated with a cleaning solution. A cleaning solution may include, for example, paracetic acid, hydrogen peroxide, peroxyacetic acid, or oxidizing chemicals. Treating may include, for example, rinsing base 104 with the cleaning solution. Treating may also include, for example, soaking base 104 in the cleaning solution. For example, base 104 may be rinsed for less than 5 minutes with the cleaning solution (such as paracetic acid). As another example, base 104 may be soaked in the cleaning solution (such as paracetic acid) for less than 5 minutes.

At 612, pieces are formed from base 104. Pieces may be formed by cutting as disclosed herein, and may be formed into, for example, ribbons, sheets, or wires.

At 614, an acid solution is prepared. The acid solution may have a pH of, for example, 2.0 to 2.2. The acid solution may include, for example, water and one or more of citric acid and ascorbic acid. The water may include 0.3 parts per million of chlorine or less. The acid solution may include a combined total of 9 grams of acids per liter of water. For example, the acid solution may include 4.5 grams of citric acid and 4.5 grams of ascorbic acid per liter of water. Preparation of the acid solution may include filtering the acid solution to remove particles. Particles 10 micrometers (μm) or larger in size (such as length, width, height, or diameter) are filtered out of the acid solution.

At 615, the pieces are washed. Washing the pieces may be performed as disclosed herein. The pieces may be washed with, for example, a washing solution. The washing solution may be, for example, water or a solution of water and one or more of vinegar, citric acid, ascorbic acid, other food-grade acids, sodium chloride, potassium chloride, or other food-grade salts. The pieces may be washed at a temperature from, for example, 10° C. to 100° C. The

At 616, the pieces are immersed in the acid solution. The acid solution may be at room temperature. Immersing the pieces may involve, for example, fully submerging the pieces within a bath of the acid solution. Immersing the pieces may involve, for example, surrounding the pieces with the acid solution. The pieces may be immersed for approximately 5 to 20 minutes. As another example, the pieces may be immersed until reaching a 3.5 to 4.4 pH.

At 620, the pieces are removed from the acid solution. After removal from the acid solution, remaining or excess acid solution adhering to the pieces may be removed by, for example, draining the acid solution from the pieces. Draining may include, for example, allowing gravity to remove acid solution from the pieces (such as by allowing the acid solution to drip off). Removing remaining acid solution may include allowing the pieces to dry under ambient conditions.

At 624, the pieces are placed in a packaging medium. The packaging medium may include a bag. The bag may be vacuum-packed to, for example, at least 91% full vacuum. The bag may be sealed with, for example, a thermal or double-thermal seal. The packaging medium may include one or more layers. The packaging medium is able to withstand temperatures of at least 100° C. for at least 30 minutes. The one or more layers may include one or more plastics, in, for example, separate layers of individual plastics or, as another example, one or more layers of blended plastics. The packaging medium may include a liquid barrier layer. The liquid barrier may be made of a plastic, such as, for example, polyethylene (such as either high-density or low-density polyethylene or both) or polypropylene. The packaging medium may include a gas barrier to prevent gases from entering. For example, the gas barrier may include nylon or polyamide. The packaging medium may be oxygen-impermeable. The packaging medium may also include a metal foil. For example, the packaging medium may include a metal foil layer.

At 628, the pieces are heated within the packaging medium. Heating may include, for example, applying heat to the exterior of the packaging medium. This may include, for example, placing the packaging medium in a water bath (for between, for example, 15 to 30 minutes, where the water is at a temperature of at least 98° C.), an autoclave, or an oven. The heating is, for example, to reach 90° C. or above of the package or the contents of the package. The heating may cause the package or its contents to reach 90° C. or above within 15 minutes or less. For example, the surface temperature of the pieces may reach at least 90° C. within 15 minutes or less due to the heating.

At 632, the pieces are cooled within the packaging medium. Cooling may include, for example, refrigeration, a cool or cold water bath, or exposure to ambient conditions.

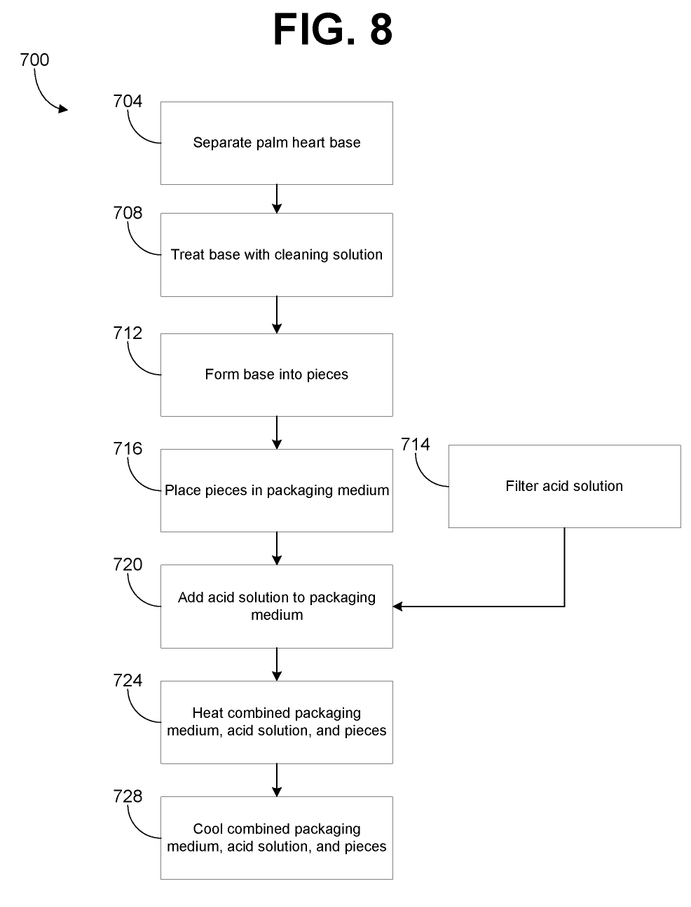

FIG. 8 is a depiction of an exemplary flow chart of method for processing heart of palm base 700.

At 704, base 104 is separated from core 108 and top 116, as disclosed herein.

At 708, base 104 is treated with a cleaning solution, as disclosed herein.

At 712, pieces are formed from base 104, as disclosed herein.

At 714, an acid solution is prepared, as discussed herein. Preparing the acid solution may include, for example, filtering the acid solution using a 10 micrometer filter.

At 716, the pieces are placed in a packaging medium, as disclosed herein.

At 720, a volume of the acid solution is added to the packaging medium prior to the sealing of the packaging medium. The volume may be sufficient to immerse the pieces within the packaging medium.

At 724, the pieces and the acid solution added to the packaging medium are heated within the packaging solution. Heating may include, for example, applying heat to the exterior of the packaging medium. This may include, for example, placing the packaging medium in a water bath (for between, for example, 15 to 30 minutes, where the water is at a temperature of at least 98° C.), an autoclave, or an oven. The heating is, for example, to reach 90° C. or above of the package or the contents of the package.

At 728, the pieces and acid solution are cooled within the packaging solution.

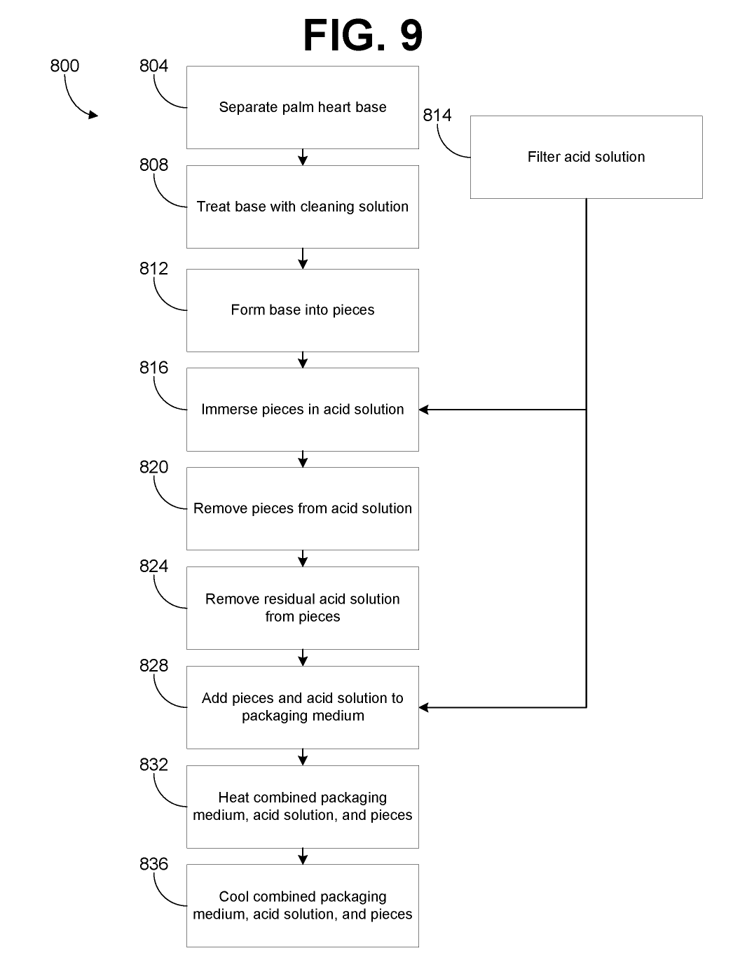

FIG. 9 is a depiction of an exemplary flow chart of method for processing heart of palm base 800.

At 804, base 104 is separated from core 108 and top 116, as disclosed herein.

At 808, base 104 is treated with a cleaning solution, as disclosed herein.

At 812, pieces are formed from base 104, as disclosed herein.

At 814, an acid solution is prepared, as disclosed herein.

At 816, the pieces are immersed in an acid solution, as disclosed herein.

At 820, the pieces are removed from the acid solution, as disclosed herein.

At 824, residual acid solution is removed from the pieces, as disclosed herein.

At 828, the pieces and a volume of acid solution are added to a packaging medium. The volume of acid solution may be sufficient to immerse the pieces within the packaging medium in the acid solution. The volume of acid solution added may be re-used from the acid solution the pieces were immersed in, or may be an unused volume of acid solution.

At 832, the pieces, acid solution, and packaging medium are heated. Heating may include, for example, applying heat to the exterior of the packaging medium. This may include, for example, placing the packaging medium in a water bath (for between, for example, 15 to 30 minutes, where the water is at a temperature of at least 98° C.), an autoclave, or an oven. The heating is, for example, to reach 90° C. or above of the package or the contents of the package. Heating may include, for example, heating in a water bath (for between, for example, 15 to 30 minutes, where the water is at a temperature of at least 98° C.), an autoclave, or an oven. The heating is, for example, to reach 90° C. or above of the package or the contents of the package.

At 832, the packaging medium, acid solution, and pieces of base 104 are cooled. Cooling may include, for example, refrigeration, a cool or cold water bath, or exposure to ambient conditions.

While processing heart of palm has been described in connection with the various embodiments of the various figures, it is to be understood that other similar embodiments may be used or modifications and additions may be made to the described embodiments of heart of palm processing without deviating therefrom. Therefore, heart of palm processing as described herein should not be limited to any single embodiment, but rather should be construed in breadth and scope in accordance with the appended claims.

1. A method for processing a palm heart base comprising:
providing a palm heart comprising a top, a core, and a base;
separating the base from the top and the core;
rinsing the base with a cleaning solution;
forming, from the base, a plurality of pieces having a thickness of 0.65 centimeters or less;
immersing the plurality of pieces in an acidic solution;
placing the plurality of pieces within an oxygen-impermeable packaging medium; and
heating the plurality of pieces to a surface temperature of at least 90 degrees Celsius,
wherein the plurality of pieces have a shear strength substantially the same as a shear strength of a piece fresh palm heart core having at least the same thickness as the plurality of pieces.

2. The method of claim 1, further comprising draining the acidic solution from the plurality of pieces.

3. The method of claim 1, further comprising filtering the acidic solution to remove particles 10 micrometers or larger in size.

4. The method of claim 1, further comprising maintaining the surface temperature of the plurality of pieces at 90 degrees or more for between 1 and 55 minutes.

5. The method of claim 1, wherein the plurality of pieces are heated to a surface temperature of at least 90 degrees Celsius in a time of 15 minutes or less.

6. The method of claim 1, wherein the plurality of pieces are immersed in the acidic solution until the plurality of pieces reaches a pH between 3.5 and 4.4.

7. The method of claim 1, wherein each piece of the plurality of pieces are formed into a ribbon or a sheet.

8. The method of claim 1, wherein the cleaning solution comprises at least one of peroxyacetic acid, peracetic acid, or hydrogen peroxide.

9. The method of claim 1, wherein the acidic solution has a pH between 1.8 and 3.3.

10. The method of claim 1, wherein the acidic solution comprises citric acid, ascorbic acid, and water.

11. A palm heart base product comprising a plurality of palm heart base pieces having a thickness of 0.65 centimeters or less contained within an oxygen-impermeable packaging medium and having a shear strength substantially the fresh palm heart core having at least the same thickness as the plurality of pieces.

12. The palm heart product of claim 11, further comprising a combination of at least two spices.

13. The palm heart product of claim 11, further comprising an acidic solution and wherein the plurality of palm heart base pieces has a pH between 3.5 and 4.4.

14. The palm heart product of claim 11, wherein the packaging medium comprises a liquid barrier and a gas barrier, and wherein the packaging medium further comprises at least one plastic, and wherein the at least one plastic comprises at least one of polyethylene, polypropylene, polyethylene terephthalate, nylon, or ethyl vinyl alcohol.

15. The palm heart product of claim 11, wherein the packaging medium comprises a flexible metal foil.
